(19) United States
(12) Patent Application Publication
(10) Pub. No.: US 2022/0403904 A1
(43) Pub. Date: Dec. 22, 2022

(54) DIAPHRAGM HOLDER FOR AN OLEO-PNEUMATIC-TYPE SHOCK ABSORBER

(71) Applicant: SAFRAN LANDING SYSTEMS, Velizy-Villacoublay (FR)

(72) Inventors: Sylvain LECLERCQ, MOISSY-CRAMAYEL (FR); Mathieu JOUBERT, MOISSY-CRAMAYEL (FR); Franck LECUYER, MOISSY-CRAMAYEL (FR); Quentin ROIRAND, MOISSY-CRAMAYEL (FR)

(73) Assignee: SAFRAN LANDING SYSTEMS, Velizy-Villacoublay (FR)

(21) Appl. No.: 17/772,687

(22) PCT Filed: Oct. 27, 2020
(86) PCT No.: PCT/EP2020/080207

§ 371 Date: Apr. 28, 2022

(30) Foreign Application Priority Data
Oct. 29, 2019 (FR) FR19 12130

(51) Int. Cl. F16F 9/06; F16F 9/32; B64C 25/60

(52) U.S. Cl. CPC F16F 9/063; F16F 9/3221; B64C 25/60; F16F 2224/0241; F16F 2230/0023; F16F 2228/007; F16F 2224/0208; F16F 2230/36; F16F 2222/126

(57) ABSTRACT

A diaphragm holder for an oleo-pneumatic-type shock absorber includes a tubular body made of thermoplastic material, having a first end arranged to hold a diaphragm provided with flow restricting orifices and an opposite second end defining an arched bottom for withstanding pressure forces. Each of the two ends is provided with a localised mechanical reinforcement element forming an axial stop arranged to allow tensile stressing of the tubular body.

The present invention relates to the field of hydaulic shock absorbers and more specifically, a diaphragm holder for an oleo-pneumatic-type shock absorber equipping in particular, although not exclusively, aircraft landers.

### BACKGROUND OF THE INVENTION

An aircraft lander generally comprises an oleo-pneumatic-type shock absorber which makes it possible to ensure the stabilisation and the control of the movements of the aircraft, in particular during taxiing and landing phases. The oleo-pneumatic-type shock absorber comprises a box in which a rod is mounted to slide. The rod holds, at its lower end, a rocker beam on which is mounted a plurality of wheels allowing the aircraft to rest on the ground.

The box and the rod together define an inner volume separated into two chambers by a diaphragm. One of the chambers is filled with a hydraulic fluid, while the other chamber is filled with the same hydraulic fluid and a pressurised gas. The diaphragm comprises calibrated orifices through which the hydraulic fluid can pass by undergoing a hydraulic resistance.

The diaphragm is traditionally held by a diaphragm holder tube integral with a bottom of the box. The diaphragm holder tube is sized to not burn under the pressure exerted by the hydraulic fluid on the diaphragm, in particular during the landing phases of the aircraft.

In certain landers, like for example those equipping the Airbus A320, the diaphragm holder tube is further arranged to ensure a retaining of the lower part of the gear holding the wheels which, under the effect of gravity, tends to extend the shock absorber when the aircraft is in flight with gear down.

Thus, the diaphragm holder tubes are generally made of metal. However, the manufacture of such diaphragm holder tubes involves expensive and long machining operations. What is more, the manufacture by machining involves minimum wall thicknesses which prevent reducing the mass of the metal diaphragm holder tubes, while they are often oversized given the forces that they undergo.

From document FR-A-2 999 528, diaphragm holder tubes made of thermoplastic material are known, allowing to decrease the mass and the manufacturing time of the diaphragm holder tubes.

However, if injection manufacturing makes it possible to optimise the shapes of the diaphragm holder tubes, in particular to decrease the mass, it moreover limits their mechanical performances necessary for the correct operation of the shock absorber, and in particular, retaining the rocker beam. Indeed, a plastic material diaphragm holder tube, of which the structure would be optimised to improve its performances, would comprise confined zones that it would be difficult, even impossible, to achieve by injection.

### AIM OF THE INVENTION

The invention therefore aims to propose a diaphragm holder allowing to at least partially prevent the abovementioned disadvantages.

### SUMMARY OF THE INVENTION

To this end, a diaphragm holder for an oleo-pneumatic-type shock absorber is proposed, which comprises a tubular body made of thermoplastic material. The tubular body has a first end arranged to hold a diaphragm provided with flow restricting orifices, and a second opposite end defining a bottom arranged to withstand pressure forces.

According to the invention, each of the two ends is provided with a localised mechanical reinforcement element forming an axial stop arranged to allow a tensile stressing of the tubular body.

The mechanical reinforcement elements allow to avoid having localised excess thicknesses of the thermoplastic material constituting the remainder of the diaphragm holder. This facilitates the manufacture of the diaphragm holder and limits the weight of it. Furthermore, for the insert, a more suitable material can be chosen for withstanding localised forces that thermoplastic material would not, which is chosen to satisfy other stresses. Thus, the mechanical characteristics of the thermoplastic material constituting the tubular body are utilised at best.

The arrangement of mechanical reinforcement elements at the ends of the tubular body allows to simplify the manufacture of the diaphragm holder while guaranteeing it mechanical performances necessary for the correct operation of the shock absorber.

Particularly, at least one of the mechanical reinforcement elements is made of metal, preferably steel or aluminium.

According to a particular characteristic, the mechanical reinforcement element arranged at the first end of the tubular body is added by screwing onto said tubular body.

Particularly, the mechanical reinforcement element arranged at the first end of the tubular body defines a cover comprising a tubular part which is engaged on the first end of the tubular body and which has a free end forming the axial stop.

Particularly, the mechanical reinforcement element arranged at the first end of the tubular body comprises a wall blocking the tubular body and in which is arranged at least one restricting orifice such that said wall forms the diaphragm.

According to another particular characteristic, the mechanical reinforcement element arranged at the second end of the tubular body comprises a yoke joint arranged to articulate the diaphragm holder to a support structure.

The invention also relates to an oleo-pneumatic-type shock absorber comprising such a diaphragm holder.

The invention also relates to an aircraft lander comprising such a shock absorber.

The invention further relates to an aircraft comprising such a lander.

### BRIEF DESCRIPTION OF THE DRAWINGS

The invention will be best understood in the light of the following description, which is purely illustrative and non-limiting, and must be read regarding the appended drawings, among which:

FIG. 1 is a schematic cross-sectional view of an aircraft lander shock absorber known per se, comprising a diaphragm holder;

FIG. 2 is an axial cross-sectional view of a diaphragm holder known per se, made of steel;

FIG. 3 is an axial cross-sectional view of a diaphragm holder according to a particular embodiment of the invention.

### DETAILED DESCRIPTION OF THE INVENTION

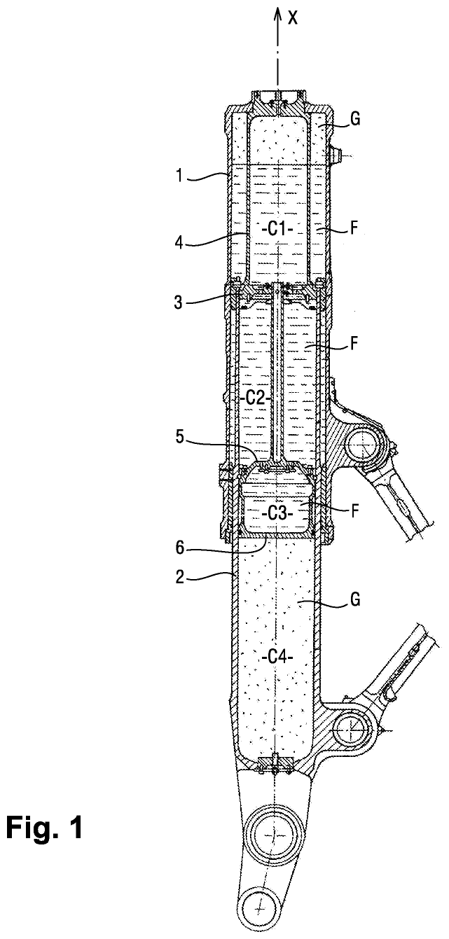

FIG. 1 represents an oleo-pneumatic-type aircraft lander shock absorber. In a manner known per se, the shock absorber has a box 1 in which a rod 2 is mounted to slide along a vertical axis X between a retracted position and an output position. A lower end of the rod 2 is arranged to receive an axle or a bogie holding one or more wheels.

A diaphragm 3 separates the inside of the box 1 into a first chamber C1 filled with a hydraulic fluid F and a pressurised gas G and a second chamber C2 filled with hydraulic fluid F. The diaphragm 3 is held by a lower end of a substantially tubular diaphragm holder 4 extending along the axis X, while an upper end of the diaphragm holder 4 is directly added onto a ceiling of the box 1.

The second chamber C2 is moreover delimited by a bottom 5 added in the rod 2. Under the bottom 5 extends a third chamber C3 filled with hydraulic fluid F and a fourth chamber C4 filled with pressurised gas G. The third chamber C3 and the fourth chamber C4 are separated by a separating piston 6.

The diaphragm 3 and the bottom 5 are provided with calibrated orifices allowing the hydraulic fluid F to pass respectively from the second chamber C2 to the first chamber C1 and from the second chamber C2 to the third chamber C3. All this is well-known and is only reminded of for illustration.

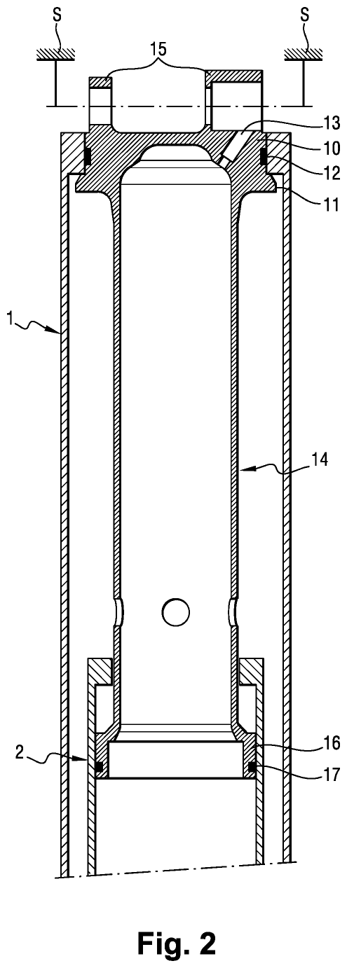

FIG. 2 illustrates a diaphragm holder 14, known in itself, made fully of metal. The diaphragm holder 14 differs from that presented in FIG. 1 in that it is arranged to ensure a retaining of the rod 2 when this is in the output position.

Thus, an upper end of the diaphragm holder 14 comprises a cylindrical seat 10 arranged to be able to be adjusted in a homologous cylindrical seat arranged in the box 1, and an outer shoulder 11 arranged downstream from the cylindrical seat 10 and bearing against a step of said box 1. The cylindrical seat 10 comprises a groove arranged to receive a seal 12, and orifice 13 for introducing gas G into the shock absorber.

Moreover, two asymmetrical yoke joints 15 extend projecting from the upper end of the diaphragm holder 14 and allow to mount the diaphragm holder 14, and therefore the shock absorber, in an articulated manner on a structure S of the aircraft via an axis, not represented here.

A lower end of the diaphragm holder 14 has a cylindrical seat 16 adapted to slide into a seat for centring the rod 2. The cylindrical seat 16 comprises a groove arranged to receive a centring block 17 and forms an axial stop against which a step of the rod 2 rests when said rod 2 is in the output position. Such an arrangement of the cylindrical seat 16 allows the rod 2 to stress the diaphragm holder 14 in a tensile manner, the upper end of which is mounted articulated on the structure S of the aircraft.

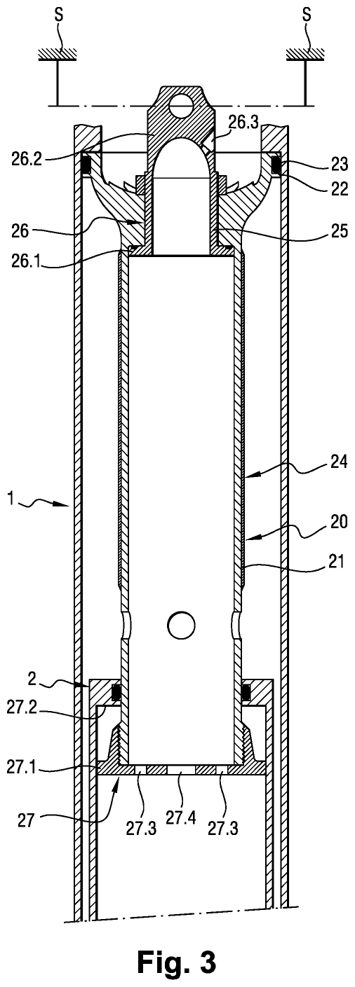

FIG. 3 illustrates a diaphragm holder 24 according to a particular embodiment of the invention. The diaphragm holder 24 comprises a substantially tubular body 20 reinforced in the central part by longitudinal stiffeners 21 regularly distributed outside of the body 20. The longitudinal stiffeners 21 run along the running part parallel to the axis X and radially projecting outwards. The body 20 is made of thermoplastic material, preferably polyetheretherketone having short carbon fibres. The density of such a material is around 1.4, to be compared with the density of a light alloy of around 2.8 and that of steel of around 7.8. The body 20 is preferably obtained by injecting in a mould, which allows to obtain a part having walls, the thickness of which is controlled over the whole length of said part and not requiring any recovery. Any this contributes to lowering the mass of the diaphragm holder, as well as its cost price.

The body 20 is, in the upper part, flared to come to an end on a cylindrical outer centring seat 22 which has an annular groove in which is housed a seal 23 bearing against the inner surface of the box 1. The upper part of the body 20 comprises an annular end face in contact with an annular shoulder of the box 1 to form an axial stop allowing a tensile stressing of the body 20 with a possible pre-stressing of said body 20 in order to avoid any detachment of the end face with the shoulder of the box 1.

Moreover, the upper end of the tubular body also comprises an inner centring seat 25 in which is added a first mechanical reinforcement element 26 of mainly cylindrical form. The first mechanical reinforcement element 26 comprises, in the lower part, an outer shoulder 26.1 resting on a step of the body 20 to prevent any exiting of said first element 26 through the upper end of the body 20. The first element 26 here comprises, in the upper part, a yoke joint 26.2 extending projecting from the body 20. The yoke joint 26.2 allows to articulate the diaphragm holder 24, and therefore the shock absorber, on the structure S of the aircraft via an axis, not represented here.

Similarly to the diaphragm holder 14, the first element 26 also comprises an orifice 26.3 for introducing gas G into the shock absorber.

The first element 26 is here made of metal, preferably steel or aluminium.

The body 20 comprises, in the lower part, an externally threaded portion on which a second mechanical reinforcement element 27 is screwed. The second element 27 forms a cover of circular contour and of which a tubular part 27.1 is internally threaded to engage with the threaded portion of the body 20.

The tubular part 27.1 has an outer diameter greater than that of the body 20 such that a free end 27.2 of said tubular part 27.1 forms an axial stop against which a step of the rod 2 can rest.

The second element 27 is moreover provided with two flow restricting orifices 27.3 of substantially idental diameter through which the hydraulic fluid F is intended to flow. The second element 27 thus forms a diaphragm.

The second element 27 is furthermore provided with a central orifice 27.4 for the passage of a metering needle, not represented here.

Just like the first element 26, the second element 27 is here made of metal, preferably steel or aluminium.

The first and second mechanical reinforcement elements 26, 27 allow the rod 2 to stress the tubular body 20 of the diaphragm holder 24 mainly in a tensile manner and therefore at best utilise the mechanical characteristics of the thermoplastic material constituting said tubular body 20.

Moreover, the assembly of the first and second elements 26, 27 on the thermoplastic material body 20 allows to simplify the manufacture of the diaphragm holder and to limit its mass, while proposing the mechanical performances of a diaphragm holder fully made of metal, like the diaphragm holder 14 illustrated in FIG. 2.

Of course, the invention is not limited to the embodiments described, but comprises any variany entering into the scope of the invention such as defined by the claims.

Although the second mechanical reinforcement element 27 is here added screwed onto the tubular body 20, other types of fixing can be considered (bolting, pinning, gluing, etc.).

The geometry and the dimensions of the first and second mechanical reinforcement elements 26, 27 can be different from those illustrated.

The first element 26 can have the form of a cover having a tubular part screwed on the upper end of the body 20, said cover comprising an annular surface portion forming an axial stop to rest against the shoulder of the box 1 and being provided with at least one yoke joint for its articulation to the structure.

The second element 27 can have the form of a ring surrounding the end of the tubular body 20, the diaphragm being formed by a separate part.

1. A diaphragm holder for an oleo-pneumatic-type shock absorber, the diaphragm holder comprising a tubular body made of thermoplastic material having a first end arranged to hold a diaphragm provided with flow restricting orifices and a second opposite end defining a bottom arranged to withstand pressure forces, each of the two ends being provided with a localised mechanical reinforcement element forming an axial stop arranged to allow a tensile stressing of the tubular body.

2. The diaphragm holder according to claim 1, wherein at least one of the mechanical reinforcement elements is made of metal.

3. The diaphragm holder according to claim 1, wherein the mechanical reinforcement element arranged at the first end of the tubular body is added by screwing onto said tubular body.

4. The diaphragm holder according to claim 3, wherein the mechanical reinforcement element arranged at the first end of the tubular body defines a cover comprising a tubular part which is engaged on said first end and which has a free end forming the axial stop.

5. The diaphragm holder according to claim 4, wherein the mechanical reinforcement element arranged at the first end of the tubular body comprises a wall blocking the tubular body and in which is arranged at least one restricting orifice such that said wall forms the diaphragm.

6. The diaphragm holder according to claim 1, wherein the mechanical reinforcement element arranged at the second end of the tubular body comprises a yoke joint arranged to articulate the diaphragm holder on a support structure.

7. An oleo-pneumatic-type shock absorber comprising the diaphragm holder according to claim 1.

8. An aircraft lander comprising the oleo-pneumatic-type shock absorber according to claim 7.

9. An Aircraft comprising the aircraft lander according to claim 8.

10. The diaphragm holder according to claim 2, wherein the at least one of the mechanical reinforcement elements is made of metal, and the metal comprises steel or aluminium.
